(19) United States
(12) Patent Application Publication
(10) Pub. No.: US 2026/0255201 A1
(43) Pub. Date: Aug. 27, 2026

(54) POWER FLUX DENSITY REPORT

(71) Applicant: QUALCOMM Incorporated, San Diego, CA (US)

(72) Inventors: Idan Michael HORN, Hod Hasharon (IL); Yehonatan DALLAL, Kfar Saba (IL); Peer BERGER, Hod Hasharon (IL); Alexander SVERDLOV, Rehovot (IL)

(21) Appl. No.: 19/064,580

(22) Filed: Feb. 26, 2025

(51) Int. Cl. H04W 24/10; H04B 7/185; H04W 16/28

(52) U.S. Cl. CPC H04W 24/10; H04B 7/18513; H04W 16/28

(57) ABSTRACT

In an aspect of the disclosure, a method, a computer-readable medium, and an apparatus are provided. The apparatus comprises at least one memory, and at least one processor coupled to the at least one memory and, based at least in part on information stored in the at least one memory, the at least one processor is configured to obtain a request to initiate a set of measurements associated with a power flux density (PFD) for communication between a set of satellites and the UE. The at least one processor is also configured to initiate, based on the request, the set of measurements associated with the PFD. The at least one processor is further configured to transmit, to at least one satellite of the set of satellites, a report of the set of measurements associated with the PFD.

### TECHNICAL FIELD

The present disclosure relates generally to communication systems, and more particularly, to wireless communication systems with a non-terrestrial network (NTN).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of later telecommunication technologies may be based on aspects of 5G NR. There exists a need for further improvements in 5G NR and future telecommunication technology, such as 6G technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus comprises at least one memory, and at least one processor coupled to the at least one memory and, based at least in part on information stored in the at least one memory, the at least one processor is configured to obtain a request to initiate a set of measurements associated with a power flux density (PFD) for communication between a set of satellites and a user equipment (UE). The at least one processor is also configured to initiate, based on the request, the set of measurements associated with the PFD. The at least one processor is further configured to transmit, to at least one satellite of the set of satellites, a report of the set of measurements associated with the PFD.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIGS. 4A and 4B are diagrams illustrating an example NTN satellite using beam directions for communication with a UE, in accordance with various aspects of the present disclosure.

FIG. 5 is a diagram showing an example of coverage areas for a beam from an NTN device, in accordance with various aspects of the present disclosure.

FIG. 6 is a diagram illustrating an example of power flux density report for NTN communication, in accordance with various aspects of the present disclosure.

FIG. 7 is a diagram showing an example of coverage areas from multiple NTN devices, in accordance with various aspects of the present disclosure.

FIG. 8 is a diagram illustrating an example of power flux density report for NTN communication, in accordance with various aspects of the present disclosure.

FIG. 9A is a flowchart of a method of wireless communication at a UE, in accordance with various aspects of the present disclosure.

FIG. 9B is a flowchart of a method of wireless communication at a UE, in accordance with various aspects of the present disclosure.

FIG. 10 is a diagram illustrating an example of a hardware implementation for an example apparatus and/or network entity.

### DETAILED DESCRIPTION

Existing non-terrestrial networks (NTN), particularly those operating in Frequency Range 2 (FR2) frequency bands, face challenges in power allocation and regulatory compliance due to power flux density (PFD) constraints (e.g., defined in dB (W/m²/1 MHz)). Current NTN systems typically rely on static power allocation models that do not adapt to real-time variations in propagation conditions, UE locations, and environmental factors. As a result, these limitations may lead to suboptimal spectral efficiency, increased power wastage, and potential violations of PFD limits, affecting both network performance and regulatory adherence.

Various aspects relate generally to adaptive power control and beamforming management in NTN communication systems. Some aspects more specifically relate to systems and methods for dynamic PFD-based power and beamforming adjustment using UE-reported PFD measurements. In some examples, the UE may receive from a satellite a request to initiate a set of measurements associated with the PFD, receive downlink signals from the satellite, initiate a PFD measurement based on the received downlink signals, and transmit a report indicating the PFD measurement to the satellite. The satellite may process the received reports and adjusts transmission/output power and/or beam characteristics/pattern accordingly.

In certain aspects, the determination of the output power level or the beam pattern may be influenced by additional factors such as beam center proximity, spatial UE population density, atmospheric conditions, and/or satellite orientation. The satellite can use these parameters to refine the transmission control strategy. Additionally or alternatively, UEs may report measurement reliability (e.g., corresponding to the UE spatial population density), and the satellite can apply a threshold-based reporting mechanism to ensure the confidence of the PFD reports used for power adjustments are sufficient.

Specifically, in some aspects, initiating the set of measurements associated with the PFD may correspond to determine the set of measurements associated with the PFD, or perform the set of measurements associated with the PFD.

In some aspects, determining or performing the set of measurements associated with the PFD may include one or more of measuring a received power of one or more transmissions associated with one or more satellites of the set of satellites, extrapolating the received power to determine a corresponding PFD value within a frequency band associated with the one or more transmissions, calculating a beamforming gain, or normalizing the beamforming gain to a configurable reference antenna aperture.

In some aspects, determining or performing the set of measurements associated with the PFD may include performing the set of measurements associated with the PFD via multiple antenna arrays of the UE.

In some aspects, determining or performing the set of measurements associated with the PFD may include determining a power measurement using an analog solution based on a radio frequency (RF) detector or a digital solution, wherein the power measurement may be based on a channel used for initiation of the set of measurements associated with the PFD.

In some aspects, the output power level or the beam pattern may be determined by taking into account at least one of a spatial population associated with the UE, an orientation or an elevation of the at least one satellite of the set of satellites, a static status of the UE, a set of beam pattern parameters of the UE, a weather prediction, or one or more PFD measurement reports associated with one or more other satellites.

In some aspects, the PFD measurement may be initiated at an interval based on at least one of a channel state information (CSI) periodicity associated with the UE or a configurable periodicity.

In some aspects, the request to initiate the set of measurements associated with the PFD indicates a set of UE capabilities for a performance of the set of measurements associated with the PFD.

In some aspects, the set of UE capabilities may include at least one of a beam width parameter, a field of view (FoV) of an antenna array of the UE, a fully digital or hybrid beamforming architecture of the UE, a size of the antenna array of the UE, or a static or dynamic status of the antenna array of the UE.

In some aspects, the request to initiate the set of measurements associated with the PFD may indicate a channel on which the UE should perform the set of measurements associated with the PFD.

In some aspects, the channel may correspond to at least one of a demodulation reference signal (DMRS), a channel state information (CSI) reference signal (RS) (CSI-RS), or a synchronization signal block (SSB).

In some aspects, the request to initiate the set of measurements associated with the PFD may indicate an amount of beams on which the UE should perform the set of measurements associated with the PFD.

In some aspects, according to the request, the UE may determine a reliability metric associated with the set of measurements associated with the PFD, wherein the reliability metric is based on at least one of an angle of arrival (AOA) estimation or a beamforming gain associated with the UE. Accordingly, the UE may transmit, to the satellites, the report of the set of measurements associated with the PFD, based on a condition that the reliability metric exceeds a threshold indicated in the request to initiate the set of measurements associated with the PFD.

In some aspects, the request to initiate the set of measurements associated with the PFD is from one satellite, where the request may configure the UE to perform the set of measurements associated with the PFD for transmissions from a different satellite of the set of satellites.

In some aspects, the report of the set of measurements associated with the PFD may indicate whether an antenna array of the UE remains static for a subsequent set of measurements associated with the PFD.

In some aspects, the report of the set of measurements associated with the PFD may indicate whether an interference affecting a measurement of the PFD is present, whether another iteration of the measurement of the PFD is suitable, and a suitable channel for a performance of a subsequent measurement.

Particular aspects of the subject matter described in this disclosure can be implemented to realize one or more of the following potential advantages. In some examples, by leveraging real-time UE-reported PFD measurements, the described techniques can be used to optimize downlink power allocation, improve spectral efficiency, and maintain compliance with regulatory PFD limits. Additionally, the described techniques can maximize satellite output power without exceeding PFD limitations, leading to higher cell throughput without utilizing additional hardware on the satellite and/or the network node (e.g., a base station).

Unlike static power allocation methods, which fail to adapt to environmental and user conditions, the proposed system ensures that satellite power control is dynamically optimized based on real-world PFD conditions measured on the ground (e.g., at the UE). Additionally, the use of closed-loop PFD reporting (e.g., the dynamic feedback mechanism disclosed herein) reduces unnecessary power allocation, which extends the satellite's operational lifespan and improves overall system energy efficiency. By integrating beamforming adjustments, the technical solution further enhances NTN coverage, ensuring that UEs at varying distances from beam centers receive reliable service without excessive power consumption. Furthermore, the system introduces a threshold-based reliability mechanism for PFD reporting, ensuring that high-confidence measurements contribute to satellite power control decisions. This improves the robustness of power adaptation while preventing erroneous or low-quality reports from affecting transmission parameters.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

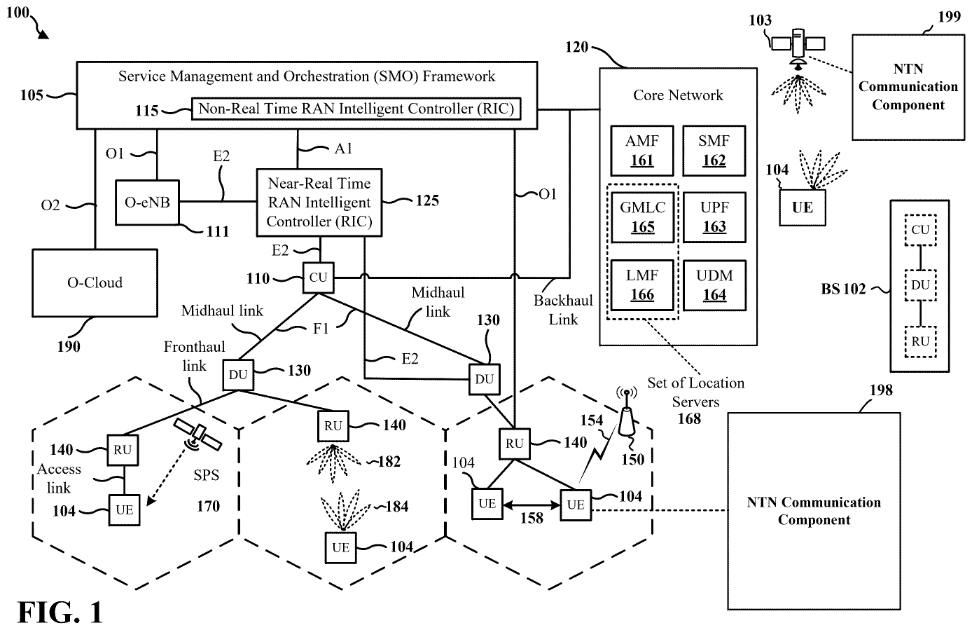

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In some aspects, an NTN device 103, such as a satellite may communicate with the UE 104. In some aspects, the NTN device 103 may be capable of performing one or more aspects performed by the base station 102. In some aspects, the NTN device 103 may be connected to the core network 120.

Referring again to FIG. 1, in certain aspects, the UE 104 may have an NTN communication component 198 that may be configured to perform the NTN communication. In some examples, the component 198 may be configured to receive from a satellite (e.g., the NTN device 103) a request to initiate a set of measurements associated with the PFD, receive downlink signals from the satellite, initiate a PFD measurement based on the received downlink signals, and transmit a report indicating the PFD measurement to the satellite.

In certain aspects, the NTN device 103 may have a component 199 that may be configured to perform the NTN communication. In some aspects, the component 199 may be configure to transmit, to the UE 104, a request to initiate a set of measurements associated with a PFD for communication between the NTN device 103 and the UE 104, receive, from the UE 104, a report of the set of measurements associated with the PFD based on the request, determine an output power level or a beam pattern based on the report of the set of measurements associated with the PFD, and transmit, to the UE 104, at least one transmission based on the output power level or the beam pattern. By leveraging real-time UE-reported PFD measurements, the described techniques may optimize downlink power allocation, improve spectral efficiency, and maintain compliance with regulatory PFD limits in NTN communications.

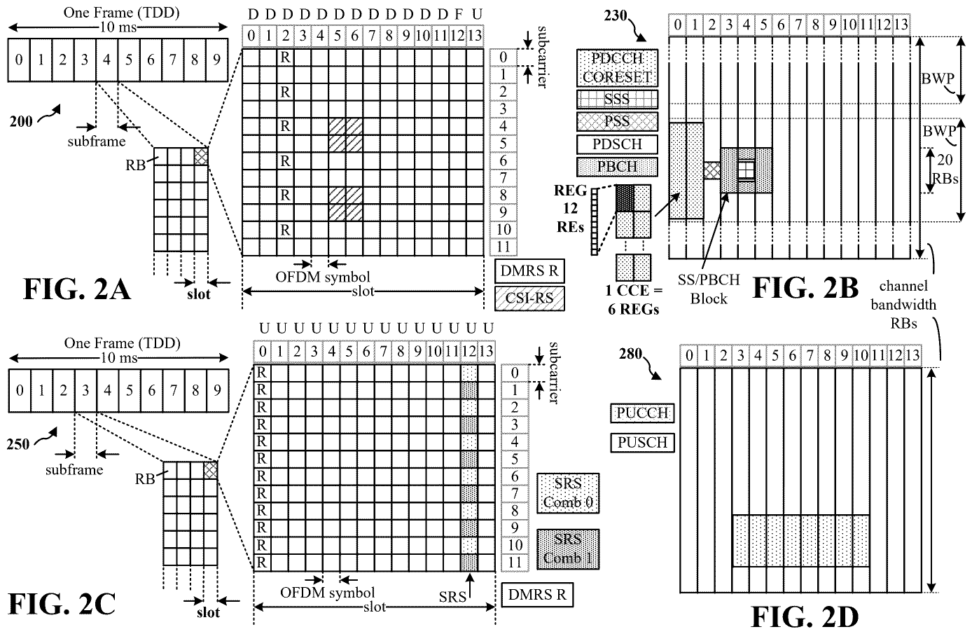

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

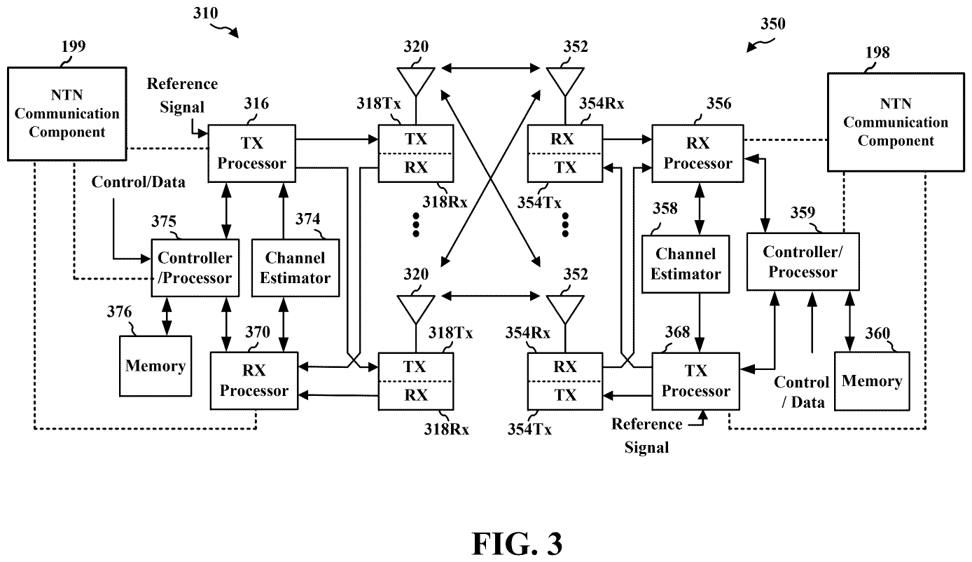

FIG. 3 is a block diagram of a network device (e.g., a base station or an NTN device such as a satellite) 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the network device 310. These soft decisions may be based on channel estimates computed by the channel estimator 358. The soft decisions are then decoded and deinterleaved to recover the data and control signals that were originally transmitted by the network device 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the network device 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the network device 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the network device 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the NTN communication component 198 of FIG. 1.

In some aspects, the NTN communication component 198 may be configured to obtain a request to initiate a set of measurements associated with a PFD for communication between a set of satellites and the UE, initiate, based on the request, the set of measurements associated with the PFD, and transmit, to at least one satellite of the set of satellites, a report of the set of measurements associated with the PFD.

In some aspects, the NTN communication component 198 may be configured to receive, from one or more satellites of the set of satellites, the request to initiate the set of measurements associated with the PFD.

In some aspects, the NTN communication component 198 may be configured to determine the set of measurements associated with the PFD or perform the set of measurements associated with the PFD.

In some aspects, the NTN communication component 198 may be configured to initiate a second set of measurements associated with the PFD at an interval based on at least one of a channel state information (CSI) periodicity associated with the UE or a configurable periodicity.

In some aspects, the NTN communication component 198 may be configured to measure a received power of one or more transmissions associated with one or more satellites of the set of satellites, and extrapolate the received power to determine a corresponding PFD value within a frequency band associated with the one or more transmissions.

In some aspects, the NTN communication component 198 may be configured to calculate a beamforming gain, and normalize the beamforming gain to a configurable reference antenna aperture.

In some aspects, the NTN communication component 198 may be configured to perform the set of measurements associated with the PFD via multiple antenna arrays of the UE.

In some aspects, the NTN communication component 198 may be configured to determine a power measurement using an analog solution based on a radio frequency (RF) detector or a digital solution, wherein the power measurement is based on a channel used for initiation of the set of measurements associated with the PFD.

In some aspects, the NTN communication component 198 may be configured to determine a reliability metric associated with the set of measurements associated with the PFD, wherein the reliability metric is based on at least one of an angle of arrival (AOA) estimation or a beamforming gain associated with the UE.

In some aspects, the NTN communication component 198 may be configured to transmit, to one or more satellites of the set of satellites, the report of the set of measurements associated with the PFD, wherein transmission of the report is based on a condition that the reliability metric exceeds a threshold indicated in the request to initiate the set of measurements associated with the PFD.

In some aspects, the NTN communication component 198 may be configured to indicate whether an antenna array of the UE remains static for a subsequent set of measurements associated with the PFD.

At least one of the TX processor 316, the RX processor 370, and the controller/processor 375 may be configured to perform aspects in connection with the NTN communication component 199 of FIG. 1.

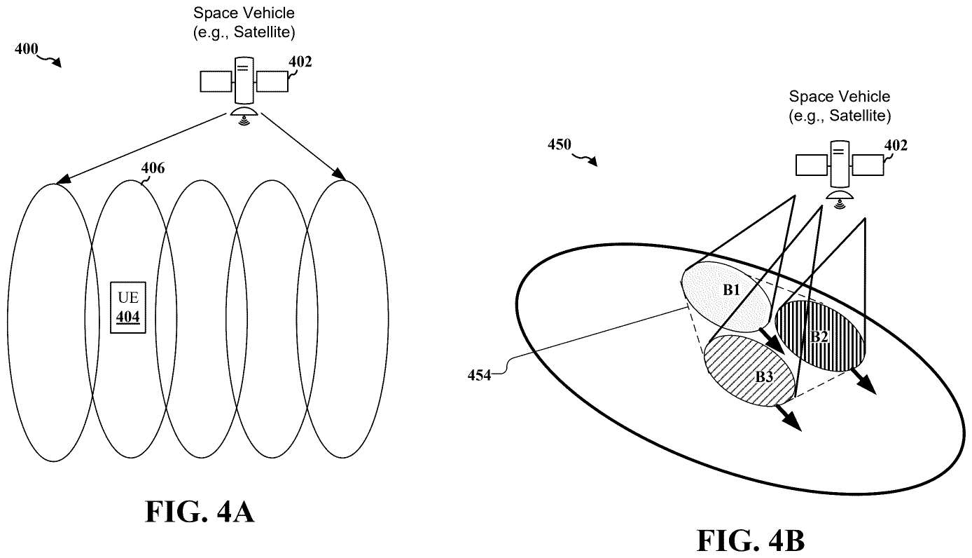

FIG. 4A is a diagram 400 illustrating an NTN device 402 (e.g., a space vehicle, such as a satellite) in communication with a UE 404. FIG. 4B illustrates radio cells produced by an NTN device 402 over an area 450, where each cell consists of one or more beams. In some aspects, the NTN device 402 may correspond to the NTN device 103 in FIG. 1 and/or the network device 310 in FIG. 3, while the UE 404 may correspond to the UE 104 in FIG. 1 and/or the UE 350 in FIG. 3.

Referring to FIG. 4A and FIG. 4B, the NTN device 402 may be equipped with antennas that provide a coverage area consisting of multiple beam footprints. For example, a coverage area 406 may be where the UE 404 is located. Beams B1, B2, and B3 may each correspond to a beamforming configuration, or may collectively form a single frequency-reuse radio cell 454.

The NTN device 402 may leverage beamforming techniques to improve spectral efficiency by steering energy toward specific UEs or regions within their coverage area. Unlike terrestrial base stations, which provide fixed, geographically stable coverage, satellites (e.g., the NTN device 402) move in orbit, causing the beam coverage (e.g., the coverage area corresponding to beams B1, B2, and/or B3) to shift over time. For example, the movement of the NTN device 402 (e.g., satellite orbital motion) may cause the beam footprint to shift over time. The UE 404 itself may also be mobile, further altering the received power level within a beam. Additionally, fluctuations in atmospheric conditions may also introduce variations in received signal strength.

Moreover, NTN communication is subject to PFD constraints, which regulate the allowable power levels at the Earth's surface to ensure efficient spectrum use and minimize interference. The constraints may serve multiple purposes, including preventing interference with terrestrial networks and adjacent satellite systems operating in the same or nearby frequency bands. The constraints also ensure compliance with regulatory standards that set maximum allowable PFD levels for different frequency bands. Additionally, by enforcing controlled power levels, PFD constraints help optimize satellite power efficiency and extend operational lifespan by preventing unnecessary power consumption.

Despite these dynamic influences, existing NTN solutions do not measure real-time PFD on the ground (e.g., at the UE level), leading to uncertainty in the actual power received at the Earth's surface. Instead, the existing NTN solutions rely on static power allocation models, where each beam is pre-configured with power level(s) and beam pattern(s), without adapting to real-time conditions. For example, in existing NTN solutions, power control may be based on:
1. Predefined link budgets:
   The NTN device 402 pre-assigns power levels to each beam based on e.g., pre-configured models, rather than real-time feedback from UEs 404.
2. Conservative Regulatory Margins:
   To avoid accidentally exceeding PFD limits, satellites may operate at lower-than-necessary power levels, which sacrifices performance and spectral efficiency.
      Although existing NTN solutions may include certain power adjustments, they are slow and infrequent. As a result, existing NTN configurations fail to adapt quickly to changing conditions of the UE, the atmosphere, and/or the interference levels.

Additionally, many factors may further influence PFD variations at the UE, such as real-time variations in propagation conditions, UE locations, environmental factors, etc. The existing NTN solutions also fail to account for those factors. Specifically, UEs located at the beam center generally experience stronger signals and more stable power levels due to the main lobe of the beam. UEs near the beam edge, however, are subject to higher path loss, weaker signals, and potential interference from adjacent beams. Existing power control models do not dynamically compensate for this spatial variation, leading to uneven service quality within the beam.

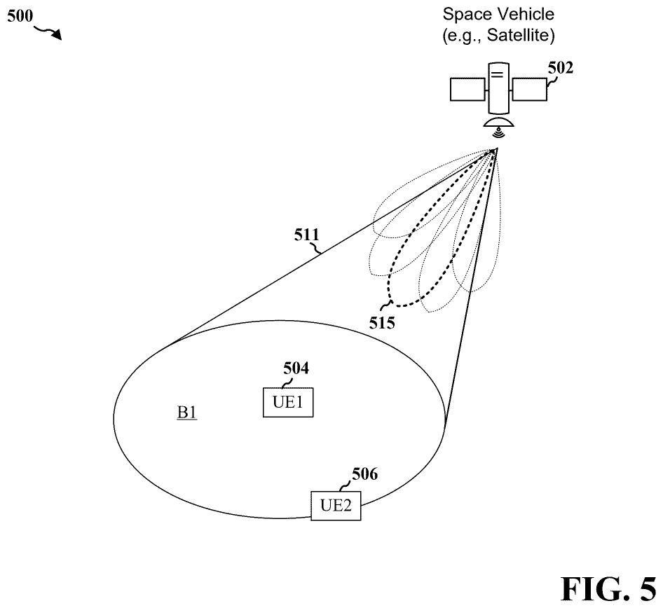

For example, FIG. 5 is a diagram 500 showing an example of coverage areas for a beam from an NTN device 502. In FIG. 5, a first beam 511 from the NTN device 502 provides a coverage area B1. In this example, UE1 504 is located closer to the center of the beam coverage area B1. UE2 506 is positioned near the boundary of the beam coverage area B1. Under the same beamforming and power configuration, UE1 504 may receive stronger signals and more stable power levels compared to UE2 506. This difference occurs because UE1 is more aligned with the main lobe 515 of beam 511, whereas UE2 experiences a smaller satellite antenna gain and potential interference due to its location near the beam edge.

Additionally, NTN signals, particularly in FR2/Ka-band frequencies, are susceptible to rain fade, ionospheric disturbances, and cloud attenuation. Existing NTN systems also do not dynamically adjust power levels based on real-time atmospheric conditions, leading to signal degradation during adverse weather. Yet, the relative position of the NTN device 402 (e.g., a satellite) with respect to the UE 404 also directly impacts received signal strength. For example, the NTN device 402 moves along its orbit, the elevation angle of the link changes, altering the path loss, Doppler shift, and received PFD at the UE. Existing NTN power control approaches do not adapt dynamically to these changes, resulting in fluctuations in service quality over time.

Accordingly, because these above discussed factors are not adequately considered in existing NTN power control and beamforming mechanisms, existing solutions often either over-allocate power (wasting energy) or under-allocate power (resulting in service degradation). The lack of real-time PFD adaptation means that NTN device 402 either exceed regulatory limits or fail to provide optimal coverage, impacting spectral efficiency and service quality.

By leveraging real-time UE-reported PFD measurements, the described techniques can be used to optimize downlink power allocation, improve spectral efficiency, and maintain compliance with regulatory PFD limits and thus, address the abovementioned issues. Unlike static power allocation methods that fail to adapt to environmental and user conditions, the proposed system dynamically optimizes satellite power control based on real-world PFD measurements at the UE, eliminating uncertainty in the power received on Earth. Additionally, the use of closed-loop PFD reporting (e.g., the dynamic feedback mechanism disclosed herein) reduces unnecessary power allocation, which extends the satellite's operational lifespan and improves overall system energy efficiency. By integrating beamforming adjustments, the technical solution further enhances NTN coverage, ensuring that UEs at varying distances from beam centers receive reliable service without excessive power consumption. Furthermore, the system introduces a threshold-based reliability mechanism for PFD reporting, ensuring that high-confidence measurements contribute to satellite power control decisions. This improves the robustness of power adaptation while preventing erroneous or low-quality reports from affecting transmission parameters.

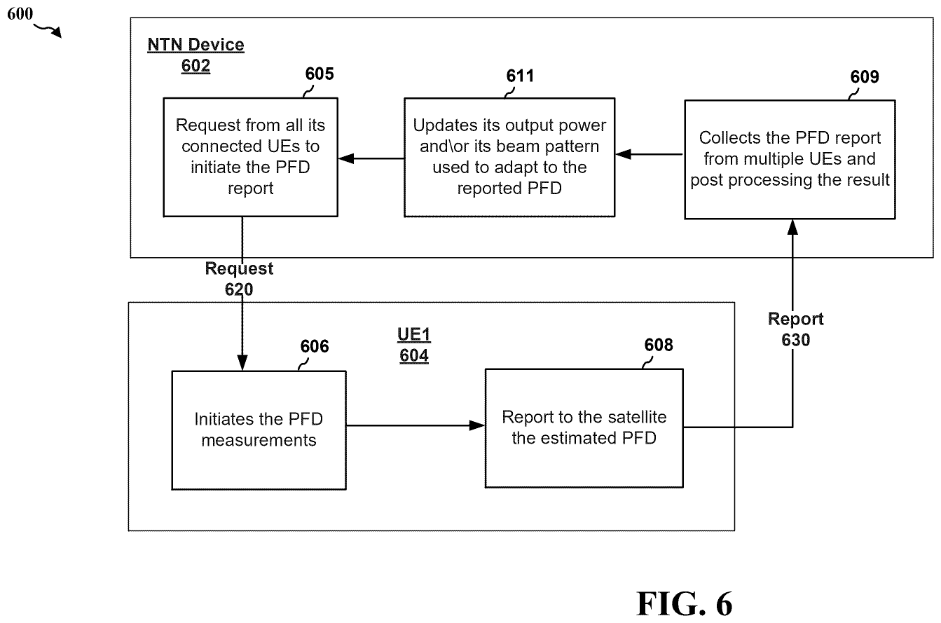

FIG. 6 is a diagram illustrating an example of power flux density report for NTN communication 600, in accordance with various aspects of the present disclosure. The NTN communication 600 may be performed between an NTN device 602 and a UE1 604. In some aspects, the NTN device 602 may correspond to the NTN device 103 in FIG. 1, the network device 310 in FIG. 3, and/or the NTN device 402 in FIGS. 4A and 4B. The UE1 604 may correspond to the UE 104 in FIG. 1, the UE 350 in FIG. 3, and/or the UE 404 in FIGS. 4A and 4B.

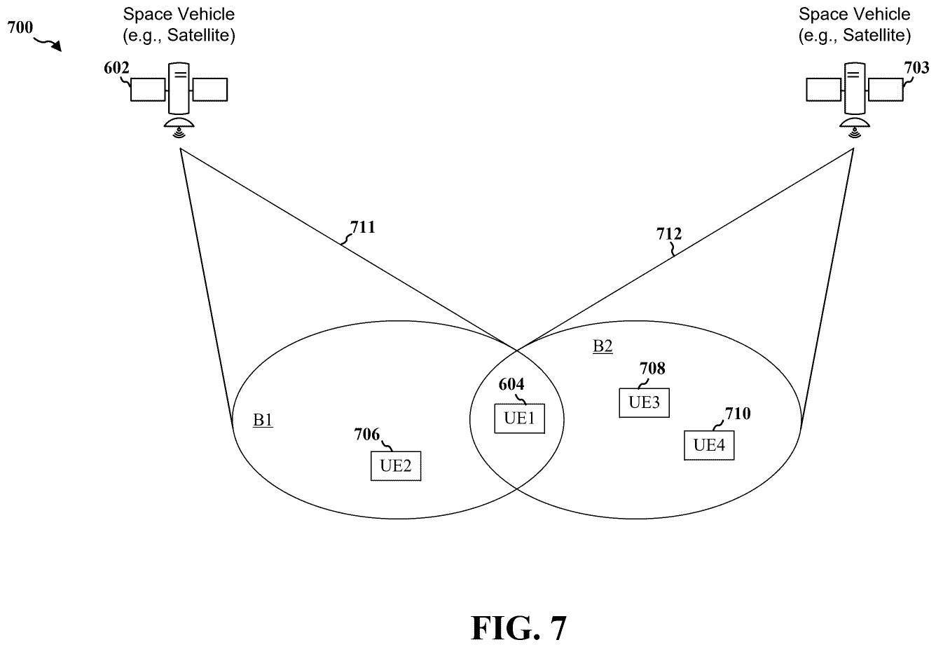

At 605, the NTN device 602 may request from all its connected UEs, including the UE1 604, to initiate a PFD report. In some aspects, the NTN device 602 may transmit a PFD measurement request (referred as “request” hereinafter) 620 to the UE1 604. For example, FIG. 7 is a diagram 700 showing an example of coverage areas from multiple NTN devices (e.g., the NTN device 602 and an NTN device 703). As illustrated in FIG. 7, a beam 711 from the NTN device 602 may provide a coverage area B1. One or more UEs (e.g., UE1 604 and UE2 706) may be located within the coverage area B1. Accordingly, the NTN device 602 may send the request 620 to all its connected UEs (e.g., UE1 604 and UE2 706) within the beam, instructing the UEs to initiate a PFD report. In some aspects, because the UE1 604 is covered by both of the coverage area B1 from the NTN device 602 and the coverage area B2 (e.g., corresponding to beam 712) of a NTN device 703, the UE1 604 may perform PFD measurements for more than one corresponding NTN devices (e.g., the NTN device 602 and the NTN device 703).

Because satellite beams (e.g., the beam 711 from the NTN device 602) do not change rapidly, a relatively long reporting interval may be used to reduce signaling overhead while still ensuring accurate power control. Accordingly, in some aspects, the PFD report periodicity and/or an interval between the two consecutive PFD reports may be based on either the CSI periodicity or a dedicated periodicity.

In some aspects, the NTN device 602 may determine which UEs should participate in PFD reporting based on UE capabilities. For example, the set of UE capabilities for the PFD reporting may include one or more of a beam width parameter; a field of view (FoV) of an antenna array of the UE, a fully digital or hybrid beamforming architecture of the UE, a size of the antenna array of the UE; or a static or dynamic status of the antenna array of the UE. In some aspects, the UE capabilities may be indicated in the request 620.

In some aspects, the NTN device 602 may specify (e.g., in the request 620) the channel on which the UE should perform PFD measurements. Examples of such channels may include a demodulation reference signal (DMRS), a channel state information (CSI)-reference signal (CSI-RS), and a synchronization signal block (SSB).

In some aspects, the NTN device 602 may define (e.g., in the request 620) the number of beams for which the UE should calculate its PFD report. In some cases, the NTN device 602 may apply a power threshold to exclude beams that are significantly below the PFD limitation. In some aspects, the NTN device 602 may instruct the UE1 604 to report the strongest beams and their respective beam offset from the PFD limitation (in dB).

In some aspects, the NTN device 602 may use different signaling methods to request PFD reports. For example, the request 620 may be signaled via broadcast channels (e.g., for system-wide PFD measurement requests), radio resource control (RRC) signaling (e.g., for configuring PFD measurement settings per UE), and/or medium access control (MAC)-control element (MAC-CE) signaling (e.g., for fast, on-demand PFD reporting).

In some aspects, the NTN device 602 may request from the UE1 604 to estimate the PFD from other satellites that operate on the same vendor. For example, as illustrated in FIG. 7, a beam 712 from the NTN device 703 (e.g., another satellite different from the NTN device 602) may provide a coverage area B2. The UE1 604 may be located within both the coverage area B1 and B2. Accordingly, the NTN device 602 may request the UE1 604 to estimate and report the PFD measurements associated with the NTN device 703. For example, the request 620 may indicate the UE1 604 to initiate a set of measurements associated with a PFD for communication between the NTN device 703 and the UE1 604.

Referring back to FIG. 6, at 606, the UE1 604 may initiate, based on the request 620 from the NTN device 602, the set of measurements associated with the PFD. In some aspects, the UE1 604 may calculate the received power based on the channel and beam configuration provided and/or specified by the NTN device 602. For example, the UE1 604 may measure the received power and may extrapolate the received power to the corresponding PFD limitation within the frequency band used. Depending on the band, the UE may sum the received power over different frequency resolutions, such as 4 kHz or 1 MHz, to obtain an accurate power measurement for PFD estimation.

In some aspects, the UE1 604 may calculate the beamforming gain and normalize it to a reference antenna aperture, such as an antenna aperture of one square meter. The normalization may compensate for beam misalignment between the UE1 604 and the NTN device 602, reducing the impact of imperfect antenna pointing toward the NTN device 602. For example, if the UE1 604 determines that the beamforming gain toward the NTN device 602 is 14 dB isotropic (dBi), but the reference gain for a one-square-meter antenna should be 40 dBi, the UE1 604 may adjust the measured power by adding 26 dB (the difference between 40 dBi and 14 dBi) to align with the PFD parameter.

In some aspects, the UE may further improve the PFD estimation by using multiple antenna panels and selecting the most accurate measurement result. In some cases, the power measurement may be performed using either an analog solution, such as an RF detector, or a digital solution, depending on the selected channel. Additionally, the UE1 604 may calculate and report the reliability of the PFD measurement, considering factors such as tolerance in the Angle of Arrival (AoA) estimation and variations in the UE1 604's beamforming gain.

In some aspects, to ensure compliance with the regulations, the UE1 604 may determine the PFD measurement on the ground while accounting for its RF parameters, as described earlier.

At 608, the UE1 604 may report the set of measurements associated with the PFD to the NTN device 602 (e.g., by sending a report 630). In some cases, the UE1 604 may report the estimated PFD for each requested satellite beam, providing the measurement as energy values (e.g., in dBm) or as a back-off (BO) value relative to the PFD limitation (in dB). If reported as a BO value, it can be both positive and negative, where a positive value indicates compliance with the PFD limitation and a negative value indicates that the satellite has exceeded the PFD threshold. The UE1 604 may report PFD measurements for specific requested NTN device (e.g., the NTN device 602). Additionally, the UE1 604 may report whether the RF plane of the UE1 604 will remain static for future measurements (e.g., providing information on whether future measurements will maintain the same orientation and/or alignment).

To enhance the accuracy of power adjustments, the UE1 604 may report the reliability of its PFD estimation, expressed either as a linear value or a percentage. In some aspects, the NTN device 602 may implement a reliability threshold (e.g., indicated in the request 620), ensuring that UEs with low-confidence measurements do not report back PFD measurements. Furthermore, the UE1 604 may indicate whether external interference has affected the PFD measurement and, if necessary, request another iteration of measurement. In such cases, the UE1 604 may also specify its suitable channel for the next measurement cycle, allowing the NTN device 602 to optimize signal selection for improved accuracy.

Since PFD compliance is maintained over the entire beam footprint, an accurate PFD estimation may include a collective PFD measurement from all UEs serviced by the beam (e.g., all UEs within coverage area of the beam). Accordingly, at 609, the NTN device 602 may collect PFD reports from multiple UEs and perform post-processing to determine appropriate adjustments in output power and/or beam management. Referring to FIG. 7, the coverage area B1 of the NTN device 602 may include multiple UEs, including UE1 604. The NTN device 602 may receive PFD measurements and corresponding reliability indicators from all UEs within coverage area B1 (e.g., the UE1 604 and the UE2 706) and processes the measurements to compute necessary adjustments in its transmission power and beam configuration.

Because each UE may have a different receive antenna array, orientation, and beamforming characteristics, which affect how the UE perceives the satellite's transmitted power, in some aspects, the NTN device 602 may estimate the PFD by aggregating and averaging PFD measurements from multiple UEs. For example, the estimated PFD for each UE may be calculated according to:

$$\text{?} = \frac{RSSI}{{A}_{e} \times BW} = \frac{RSSI}{BW} \frac{4 π}{{λ}^{2} G ( θ , ϕ )}$$

where RSSI is the received signal strength indicator (RSSI), BW is the bandwidth, Aₑ is the effective aperture of the UE antenna, λ is the signal wavelength, and G(θ, φ) represents the UE's beamforming gain in a given direction.

Additionally, or alternatively, in some aspects, when determining output power or beam management, the NTN device 602 may consider other available information, such as:
UE location relative to the beam center—UEs further from the beam center generally experience lower received power, specifying compensation through beamforming or power adjustments;
UE spatial population density—In regions with higher UE density and low variance among PFD reports, the aggregated measurement reliability increases, enabling more confident power control decisions;
Satellite orientation and elevation—The NTN device 602 may adjust power or beam configurations based on its orbital position and the elevation angle of the link;
UE-reported parameters—Information on beam pattern characteristics and whether the UE is static or mobile;
Weather conditions—The NTN device 602 may integrate weather predictions from onboard sensors (e.g., camera sensor) or external sources (e.g., internet-based forecasts) to adjust power in response to expected atmospheric attenuation; and
Reports from other satellites—The NTN device 602 may receive PFD reports from other satellites (e.g., NTN device 703 in FIG. 7, the coverage area B2 of which includes UE1 604, UE3 708, and UE4 710) covering overlapping areas to coordinate power allocation and beamforming configurations.

At 611, the NTN device 602 may update its output power and/or beam pattern in response to the reported PFD measurements from UEs. The NTN device 602 can increase or decrease its equivalent isotropically radiated power (EIRP) based on one or more factors, including:
The output power of the power amplifiers (Pas);
The beam pattern, which may be adjusted to modify the gain distribution across spatial regions;
Ensuring compliance with PFD limitations, preventing excessive transmission power that could interfere with terrestrial or adjacent satellite systems; and/or
Adhering to equivalent power flux density (EPFD) downlink constraints, as specified by regulatory standards, while considering additional parameters such as:
   PFD reports from UEs connected to other satellites in overlapping coverage areas;
   Locations of GEO ground stations, which may impose interference constraints on LEO satellite transmissions; and/or
   The serving LEO satellite's current location and beam configuration.
      Additionally, the NTN device 602 may manage closed-loop power control periodically based on the velocity and beam management changes of the NTN device 602. In some aspects, the NTN device 602 may manage its closed-loop power control for each operating band.

In some aspects, the NTN device 602 may transmit another request 620 to the UE1 604 to initiate a second set of measurements associated with the PFD at an interval based on at least one of CSI periodicity associated with the UE1 604 or a configurable periodicity.

It is understood that the number of beams per NTN device and the number of UEs within the coverage area as shown in FIG. 7 and as discussed herein are provided for illustrative purposes. The described methods and techniques apply to any suitable number of UEs and beams, and the implementation is not limited to a specific network configuration. The approach remains adaptable to various satellite architectures, deployment scenarios, and system capacities, ensuring flexibility across different NTN configurations.

Aspects presented herein may measure the power flux density (PFD) at terminals, so that a satellite can perform adaptive power control while meeting regulatory conditions. This may be important for FR2-NTN since aspects such as atmospheric fluctuations can reduce the received power in a surface of the Earth by several dB, which may be compensated by additional power at a satellite.

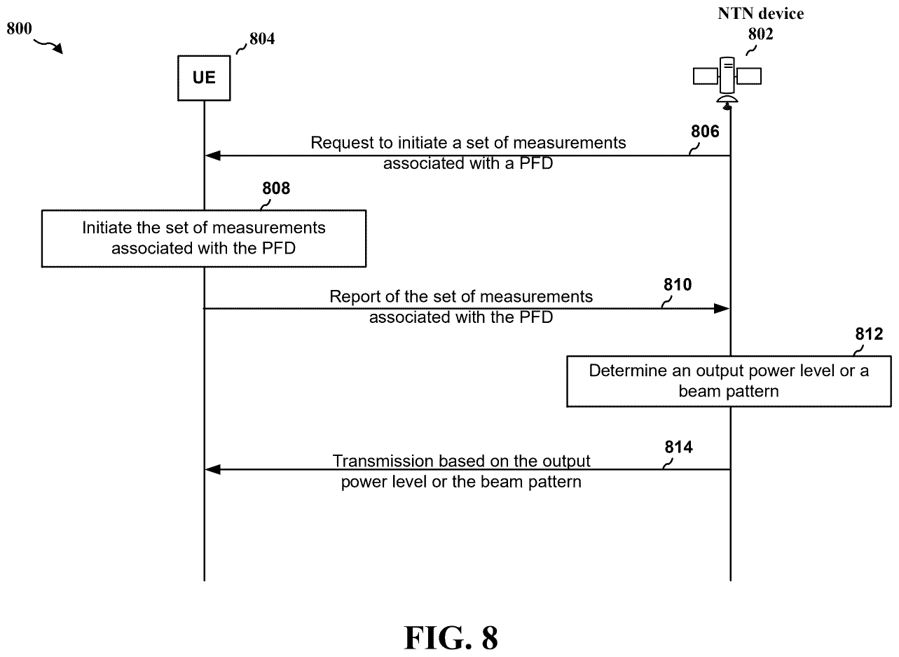

FIG. 8 is a diagram 800 illustrating an example of power flux density report for NTN communication, in accordance with various aspects of the present disclosure. The power flux density report for NTN communication may be performed between an NTN device 802 and a UE 804. In some aspects, the NTN device 802 may correspond to the NTN device 103 in FIG. 1, the network device 310 in FIG. 3, the NTN device 402 in FIGS. 4A and 4B, and/or the NTN device 602 in FIG. 6 and FIG. 7. The UE 804 may correspond to the UE 104 in FIG. 1, the UE 350 in FIG. 3, the UE 404 in FIGS. 4A and 4B, and/or the UE1 604 in FIG. 6 and FIG. 7. The diagram 800 may be understood in connection with the discussion of FIG. 6.

At 806, the NTN device 802 may transmit a request (e.g., the request 620 in FIG. 6) to the UE 804 (e.g., one of the UEs within the beam coverage of the NTN device 802, such as UE1 604 and UE2 706 in FIG. 7) to initiate a set of measurements associated with PFD for communication between the satellite and UE 804, as discussed at 605 in FIG. 6.

At 808, the UE 804 may initiate the set of measurements associated with the PFD, as discussed at 606 in FIG. 6.

At 810, the UE 804 may transmit a report (e.g., the report 630 in FIG. 6) to the NTN device 802 (e.g., one of the satellites, such as NTN device 602 and NTN device 703 in FIG. 7, whose beam coverage includes UE 804) containing the set of measurements associated with the PFD, as discussed at 608 in FIG. 6.

At 812, the NTN device 802 may determine an output power level or a beam pattern based on the report of the set of measurements associated with the PFD, as discussed at 609 and 611 in FIG. 6.

At 814, the NTN device 802 may transmit to the at least one UE, at least one transmission based on the output power level or the beam pattern determined based on the report of the set of measurements associated with the PFD.

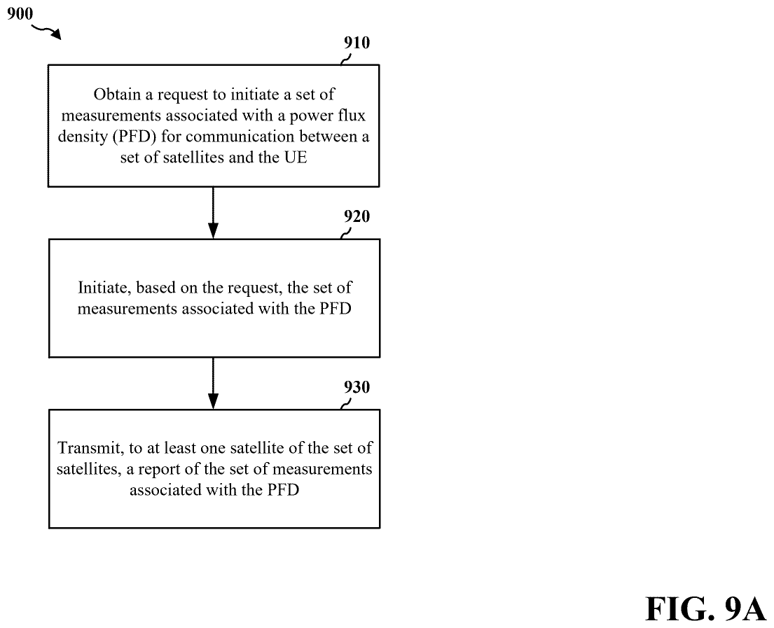

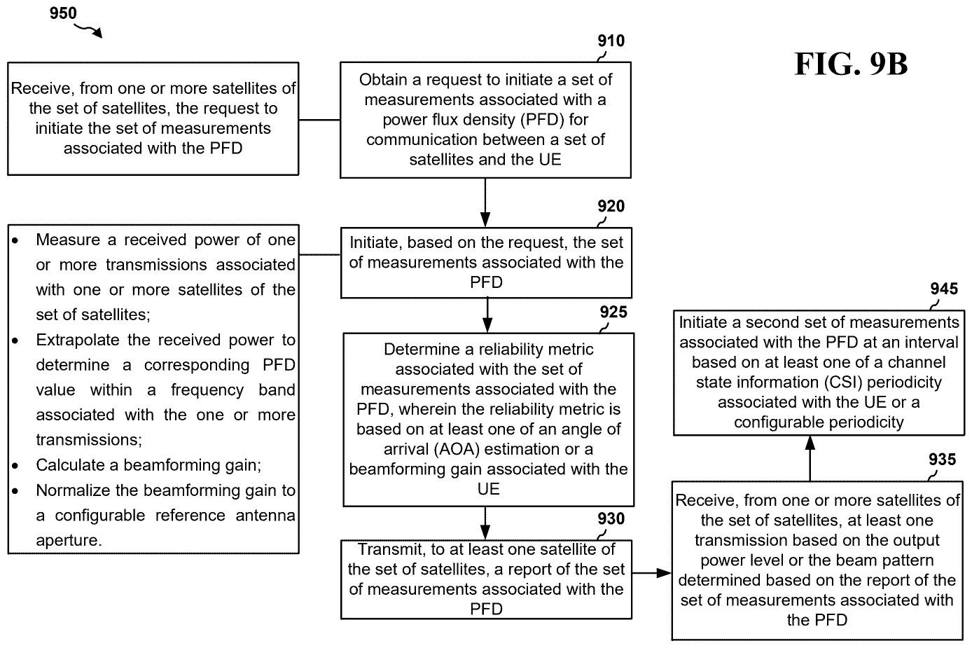

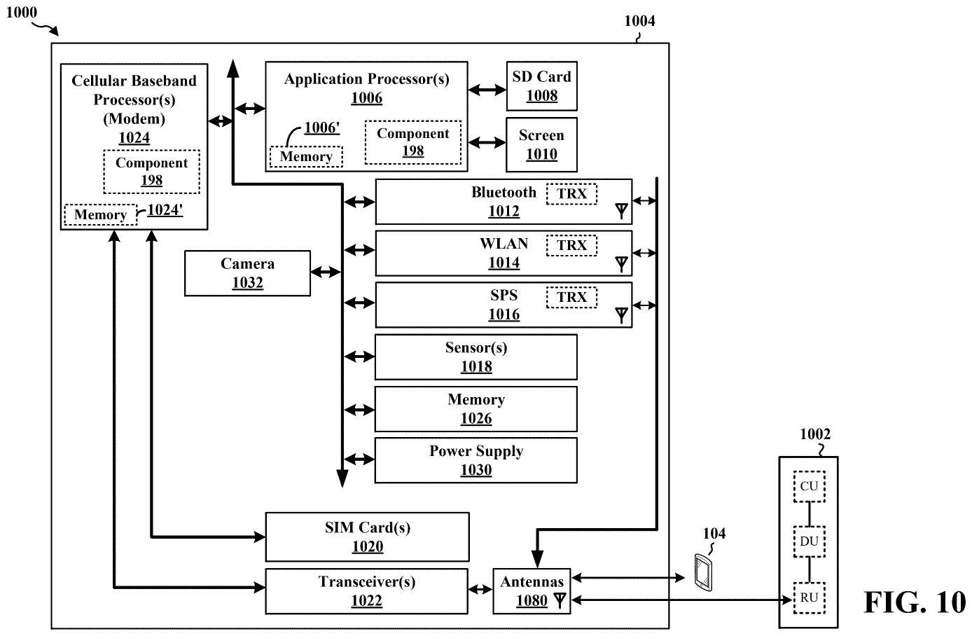

FIG. 9A is a flowchart 900 of methods of wireless communication at a UE, in accordance with various aspects of the present disclosure. The UE may correspond to the UE 104 in FIG. 1, the UE 350 in FIG. 3, the UE 404 in FIGS. 4A and 4B, the UE1 604 in FIG. 6 and FIG. 7, the UE 804 in FIG. 8, or the apparatus 1004 in the hardware implementation of FIG. 10. The method enhances NTN communication performance by enabling the satellite (e.g., NTN device 103 in FIG. 1, network device 310 in FIG. 3, NTN device 402 in FIGS. 4A and 4B, NTN device 602 in FIG. 6 and FIG. 7, or NTN device 802 in FIG. 8) to continuously optimize power allocation and beam management based on real-time UE-reported PFD measurements. The flowchart 900 may be understood in connection with the discussion of FIG. 6.

At 910, the UE may obtain a request (e.g., the request 620 in FIG. 6) to initiate a set of measurements associated with a PFD for communication between a set of satellites and the UE, as described in connection with the examples in FIGS. 1-8. For example, as described in 806 of FIG. 8, UE 804 may obtain a request (e.g., the request 620 in FIG. 6) to initiate a set of measurements associated with a PFD for communication between a set of satellites and the UE. Further, step 910 may be performed by component 198 in FIG. 1. Step 910 is also discussed at 605 and 611 in FIG. 6.

In some aspects, 910 may be performed by, e.g., the NTN communication component 198, the SPS module 1016, the transceiver(s) 1022, the cellular baseband processor(s) 1024, and/or the application processor(s) 1006 of the apparatus 1004 in FIG. 10.

At 920, the UE may initiate, based on the request, the set of measurements associated with the PFD, as described in connection with the examples in FIGS. 1-8. For example, as described in 808 of FIG. 8, UE 804 may initiate, based on the request, the set of measurements associated with the PFD. Further, step 920 may be performed by component 198 in FIG. 1. Step 920 is also discussed at 606 and 611 in FIG. 6.

In some aspects, 920 may be performed by, e.g., the NTN communication component 198, the SPS module 1016, the transceiver(s) 1022, the cellular baseband processor(s) 1024, and/or the application processor(s) 1006 of the apparatus 1004 in FIG. 10.

At 930, the UE may transmit, to at least one satellite of the set of satellites, a report (e.g., the report 630 in FIG. 6) of the set of measurements associated with the PFD, as described in connection with the examples in FIGS. 1-8. For example, as described in 810 of FIG. 8, UE 804 may transmit, to at least one satellite of the set of satellites, a report (e.g., the report 630 in FIG. 6) of the set of measurements associated with the PFD. Further, step 930 may be performed by component 198 in FIG. 1. Step 930 is also discussed at 608 in FIG. 6.

In some aspects, 930 may be performed by, e.g., the NTN communication component 198, the SPS module 1016, the transceiver(s) 1022, the cellular baseband processor(s) 1024, and/or the application processor(s) 1006 of the apparatus 1004 in FIG. 10.

FIG. 9B is a flowchart 950 of methods of wireless communication at a UE, in accordance with various aspects of the present disclosure. The UE may correspond to the UE 104 in FIG. 1, the UE 350 in FIG. 3, the UE 404 in FIGS. 4A and 4B, the UE1 604 in FIG. 6 and FIG. 7, the UE 804 in FIG. 8, or the apparatus 1004 in the hardware implementation of FIG. 10. The method enhances NTN communication performance by enabling the satellite (e.g., NTN device 103 in FIG. 1, network device 310 in FIG. 3, NTN device 402 in FIGS. 4A and 4B, NTN device 602 in FIG. 6 and FIG. 7, or NTN device 802 in FIG. 8) to continuously optimize power allocation and beam management based on real-time UE-reported PFD measurements. Some aspects of FIG. 9B may be similar to the aspects of FIG. 9A and are shown with the same reference number. The flowchart 950 may be understood in connection with the discussion of FIG. 6.

At 910, the UE may obtain a request to initiate a set of measurements associated with a PFD for communication between a set of satellites and the UE, as described in connection with the examples in FIGS. 1-8. For example, as described in 806 of FIG. 8, UE 804 may obtain a request (e.g., the request 620 in FIG. 6) to initiate a set of measurements associated with a PFD for communication between a set of satellites and the UE. Further, step 910 may be performed by component 198 in FIG. 1. Step 910 is also discussed at 605 and 611 in FIG. 6. For example, as discussed in FIG. 7, the UE may communicate with more than one satellite (e.g., the NTN device 602 and the NTN device 703). Accordingly, the UE may receive from one or more satellites of the set of satellites (e.g., one or more of the satellite the UE connected with), the request to initiate the set of measurements associated with the PFD.

In some aspects, the request to initiate the set of measurements associated with the PFD indicates a set of UE capabilities for a performance of the set of measurements associated with the PFD.

In some aspects, the set of UE capabilities may include at least one of a beam width parameter, a FoV of an antenna array of the UE, a fully digital or hybrid beamforming architecture of the UE, a size of the antenna array of the UE, or a static or dynamic status of the antenna array of the UE.

In some aspects, the request to initiate the set of measurements associated with the PFD may indicate a channel on which the UE should perform the set of measurements associated with the PFD.

In some aspects, the channel may correspond to at least one of a demodulation reference signal (DMRS), a channel state information (CSI) reference signal (RS) (CSI-RS), or a synchronization signal block (SSB).

In some aspects, the request to initiate the set of measurements associated with the PFD may indicate an amount of beams on which the UE should perform the set of measurements associated with the PFD.

In some aspects, the request to initiate the set of measurements associated with the PFD is from one satellite (e.g., the NTN device 602 in FIG. 7), where the request may configure the UE to perform the set of measurements associated with the PFD for transmissions from a different satellite of the set of satellites (e.g., the NTN device 703 in FIG. 7).

In some aspects, 910 may be performed by, e.g., the NTN communication component 198, the SPS module 1016, the transceiver(s) 1022, the cellular baseband processor(s) 1024, and/or the application processor(s) 1006 of the apparatus 1004 in FIG. 10.

At 920, the UE may initiate, based on the request (e.g., the request 620 in FIG. 6), the set of measurements associated with the PFD, as described in connection with the examples in FIGS. 1-8. For example, as described in 808 of FIG. 8, UE 804 may initiate, based on the request, the set of measurements associated with the PFD. Further, step 920 may be performed by component 198 in FIG. 1. Step 920 is also discussed at 606 and 611 in FIG. 6. In some aspects, initiating the set of measurements associated with the PFD may correspond to determine the set of measurements associated with the PFD, or perform the set of measurements associated with the PFD.

In some aspects, determining or performing the set of measurements associated with the PFD may include one or more of measuring a received power of one or more transmissions associated with one or more satellites of the set of satellites, extrapolating the received power to determine a corresponding PFD value within a frequency band associated with the one or more transmissions, calculating a beamforming gain, or normalizing the beamforming gain to a configurable reference antenna aperture, as discussed at 606 in FIG. 6.

In some aspects, determining or performing the set of measurements associated with the PFD may include performing the set of measurements associated with the PFD via multiple antenna arrays of the UE.

In some aspects, determining or performing the set of measurements associated with the PFD may include determining a power measurement using an analog solution based on a radio frequency (RF) detector or a digital solution, wherein the power measurement may be based on a channel used for initiation of the set of measurements associated with the PFD.

In some aspects, 920 may be performed by, e.g., the NTN communication component 198, the SPS module 1016, the transceiver(s) 1022, the cellular baseband processor(s) 1024, and/or the application processor(s) 1006 of the apparatus 1004 in FIG. 10.

At 925, the UE may determine a reliability metric associated with the set of measurements associated with the PFD, where the reliability metric is based on at least one of an angle of arrival (AOA) estimation or a beamforming gain associated with the UE, as described in connection with the examples in FIGS. 1-8. Specifically, according to the request, the UE may determine a reliability metric associated with the set of measurements associated with the PFD. Accordingly, the UE may transmit, to the satellites, the report of the set of measurements associated with the PFD, based on a condition that the reliability metric exceeds a threshold indicated in the request to initiate the set of measurements associated with the PFD.

In some aspects, 925 may be performed by, e.g., the NTN communication component 198, the SPS module 1016, the transceiver(s) 1022, the cellular baseband processor(s) 1024, and/or the application processor(s) 1006 of the apparatus 1004 in FIG. 10.

At 930, the UE may transmit, to at least one satellite of the set of satellites, a report (e.g., the report 630 in FIG. 6) of the set of measurements associated with the PFD, as described in connection with the examples in FIGS. 1-8. For example, as described in 810 of FIG. 8, UE 804 may transmit, to at least one satellite of the set of satellites, a report (e.g., the report 630 in FIG. 6) of the set of measurements associated with the PFD. Further, step 930 may be performed by component 198 in FIG. 1. Step 930 is also discussed at 608 in FIG. 6.

In some aspects, the report of the set of measurements associated with the PFD may indicate whether an antenna array of the UE remains static for a subsequent set of measurements associated with the PFD.

In some aspects, the report of the set of measurements associated with the PFD may indicate whether an interference affecting a measurement of the PFD is present, whether another iteration of the measurement of the PFD is suitable, and a suitable channel for a performance of a subsequent measurement.

In some aspects, 930 may be performed by, e.g., the NTN communication component 198, the SPS module 1016, the transceiver(s) 1022, the cellular baseband processor(s) 1024, and/or the application processor(s) 1006 of the apparatus 1004 in FIG. 10.

At 935, the UE may receive, from one or more satellites of the set of satellites, at least one transmission based on the output power level or the beam pattern determined based on the report of the set of measurements associated with the PFD, as described in connection with the examples in FIGS. 1-8. For example, as described in 814 of FIG. 8, UE 804 receive, from one or more satellites of the set of satellites, at least one transmission based on the output power level or the beam pattern determined based on the report of the set of measurements associated with the PFD. Further, step 935 may be performed by component 198 in FIG. 1. Step 930 is also discussed at 608 in FIG. 6.

In some aspects, the output power level or the beam pattern may be determined by taking into account at least one of a spatial population associated with the UE, an orientation or an elevation of the at least one satellite of the set of satellites, a static status of the UE, a set of beam pattern parameters of the UE, a weather prediction, or one or more PFD measurement reports associated with one or more other satellites.

In some aspects, 935 may be performed by, e.g., the NTN communication component 198, the SPS module 1016, the transceiver(s) 1022, the cellular baseband processor(s) 1024, and/or the application processor(s) 1006 of the apparatus 1004 in FIG. 10.

At 945, the UE may initiate a second set of measurements associated with the PFD at an interval based on at least one of a channel state information (CSI) periodicity associated with the UE or a configurable periodicity, as described in connection with the examples in FIGS. 1-8.

In some aspects, 945 may be performed by, e.g., the NTN communication component 198, the SPS module 1016, the transceiver(s) 1022, the cellular baseband processor(s) 1024, and/or the application processor(s) 1006 of the apparatus 1004 in FIG. 10.

FIG. 10 is a diagram 1000 illustrating an example of a hardware implementation for an apparatus 1004. The apparatus 1004 may be a UE, a component of a UE, or may implement UE functionality. In some aspects, the apparatus 1004 may correspond to the UE 104 in FIG. 1, the UE 350 in FIG. 3, the UE 404 in FIGS. 4A and 4B, the UE1 604 in FIG. 6 and FIG. 7, the UE 804 in FIG. 8, or the UE discussed in FIG. 9A and FIG. 9B. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) 1024 communicates through the transceiver(s) 1022 via one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The cellular baseband processor(s) 1024 and the application processor(s) 1006 are configured to perform the various functions described supra based at least in part of the information stored in the memory. That is, the cellular baseband processor(s) 1024 and the application processor(s) 1006 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the NTN communication component 198 may be configured to obtain a request to initiate a set of measurements associated with a PFD for communication between a set of satellites and the UE, initiate, based on the request, the set of measurements associated with the PFD, and transmit, to at least one satellite of the set of satellites, a report of the set of measurements associated with the PFD. The NTN communication component 198 may be within the cellular baseband processor(s) 1024, the application processor(s) 1006, or both the cellular baseband processor(s) 1024 and the application processor(s) 1006. The NTN communication component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for receiving, from one or more satellites of the set of satellites, the request to initiate the set of measurements associated with the PFD; obtaining a request to initiate a set of measurements associated with a power flux density (PFD) for communication between a set of satellites and the UE; initiating, based on the request, the set of measurements associated with the PFD; transmitting, to at least one satellite of the set of satellites, a report of the set of measurements associated with the PFD, determining the set of measurements associated with the PFD; performing the set of measurements associated with the PFD, receiving, from one or more satellites of the set of satellites, one or more transmissions associated with an output power level or a beam pattern based on the report of the set of measurements associated with the PFD; initiating a second set of measurements associated with the PFD at an interval based on at least one of a channel state information (CSI) periodicity associated with the UE or a configurable periodicity; measuring a received power of one or more transmissions associated with one or more satellites of the set of satellites; extrapolating the received power to determine a corresponding PFD value within a frequency band associated with the one or more transmissions; calculating a beamforming gain; and normalizing the beamforming gain to a configurable reference antenna aperture; performing the set of measurements associated with the PFD via multiple antenna arrays of the UE; determining a power measurement using an analog solution based on a radio frequency (RF) detector or a digital solution, wherein the power measurement is based on a channel used for initiation of the set of measurements associated with the PFD; determining a reliability metric associated with the set of measurements associated with the PFD, wherein the reliability metric is based on at least one of an angle of arrival (AOA) estimation or a beamforming gain associated with the UE; transmitting, to one or more satellites of the set of satellites, the report of the set of measurements associated with the PFD, wherein transmission of the report is based on a condition that the reliability metric exceeds a threshold indicated in the request to initiate the set of measurements associated with the PFD; and indicating whether an antenna array of the UE remains static for a subsequent set of measurements associated with the PFD. The means may be the NTN communication component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

As discussed above, by leveraging real-time UE-reported PFD measurements, the described techniques can be used to optimize downlink power allocation, improve spectral efficiency, and maintain compliance with regulatory PFD limits.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising obtaining a request to initiate a set of measurements associated with a power flux density (PFD) for communication between a set of satellites and the UE; initiating, based on the request, the set of measurements associated with the PFD; and transmitting, to at least one satellite of the set of satellites, a report of the set of measurements associated with the PFD.

Aspect 2 is the method of aspect 1, wherein obtaining the request to initiate the set of measurements associated with the PFD comprises: receiving, from one or more satellites of the set of satellites, the request to initiate the set of measurements associated with the PFD.

Aspect 3 is the method of any of aspects 1 and 2, wherein initiating, based on the request, the set of measurements associated with the PFD comprises: determining the set of measurements associated with the PFD; or performing the set of measurements associated with the PFD.

Aspect 4 is the method of any of aspects 1 to 3, further comprising: receiving, from one or more satellites of the set of satellites, one or more transmissions associated with an output power level or a beam pattern based on the report of the set of measurements associated with the PFD.

Aspect 5 is the method of any of aspects 1 to 4, wherein the output power level or the beam pattern is further based on at least one of: a location of the UE with respect to a center of a beam associated with the one or more transmissions; a spatial population associated with the UE; an orientation or an elevation of the at least one satellite of the set of satellites; a static status of the UE; a set of beam pattern parameters of the UE; a weather prediction; or one or more PFD measurement reports associated with one or more other satellites.

Aspect 6 is the method of any of aspects 1 to 5, further comprising: initiating a second set of measurements associated with the PFD at an interval based on at least one of a channel state information (CSI) periodicity associated with the UE or a configurable periodicity.

Aspect 7 is the method of any of aspects 1 to 6, wherein the request to initiate the set of measurements associated with the PFD indicates a set of UE capabilities for a performance of the set of measurements associated with the PFD.

Aspect 8 is the method of any of aspects 1 to 7, wherein the set of UE capabilities comprises at least one of: a beam width parameter; a field of view (FoV) of an antenna array of the UE; a fully digital or hybrid beamforming architecture of the UE; a size of the antenna array of the UE; or a static or dynamic status of the antenna array of the UE.

Aspect 9 is the method of any of aspects 1 to 8, wherein the request to initiate the set of measurements associated with the PFD indicates a channel on which the UE should perform the set of measurements associated with the PFD.

Aspect 10 is the method of any of aspects 1 to 9, wherein the channel corresponds to at least one of a demodulation reference signal (DMRS), a channel state information (CSI) reference signal (RS) (CSI-RS), or a synchronization signal block (SSB).

Aspect 11 is the method of any of aspects 1 to 10, wherein the request to initiate the set of measurements associated with the PFD indicates an amount of beams on which the UE should perform the set of measurements associated with the PFD.

Aspect 12 is the method of any of aspects 1 to 11, wherein initiating, based on the request, the set of measurements associated with the PFD comprises: measuring a received power of one or more transmissions associated with one or more satellites of the set of satellites; and extrapolating the received power to determine a corresponding PFD value within a frequency band associated with the one or more transmissions.

Aspect 13 is the method of any of aspects 1 to 12, wherein initiating, based on the request, the set of measurements associated with the PFD comprises: calculating a beamforming gain; and normalizing the beamforming gain to a configurable reference antenna aperture.

Aspect 14 is the method of any of aspects 1 to 13, wherein initiating, based on the request, the set of measurements associated with the PFD comprises: performing the set of measurements associated with the PFD via multiple antenna arrays of the UE.

Aspect 15 is the method of any of aspects 1 to 14, wherein initiating, based on the request, the set of measurements associated with the PFD comprises: determining a power measurement using an analog solution based on a radio frequency (RF) detector or a digital solution, wherein the power measurement is based on a channel used for initiation of the set of measurements associated with the PFD.

Aspect 16 is the method of any of aspects 1 to 15, further comprising: determining a reliability metric associated with the set of measurements associated with the PFD, wherein the reliability metric is based on at least one of an angle of arrival (AOA) estimation or a beamforming gain associated with the UE.

Aspect 17 is the method of any of aspects 1 to 16, further comprising: transmitting, to one or more satellites of the set of satellites, the report of the set of measurements associated with the PFD, wherein transmission of the report is based on a condition that the reliability metric exceeds a threshold indicated in the request to initiate the set of measurements associated with the PFD.

Aspect 18 is the method of any of aspects 1 to 17, wherein the request to initiate the set of measurements associated with the PFD is from one or more satellites of the set of satellites, and wherein the request configures the UE to perform the set of measurements associated with the PFD for transmissions from a different satellite of the set of satellites.

Aspect 19 is an apparatus for wireless communication at a UE, comprising: at least one memory; and at least one processor coupled to the at least one memory, the at least one processor is configured to perform the method of any of aspects 1 to 18.

Aspect 20 is the apparatus of aspect 19, further comprising a transceiver configured to receive or to transmit in association with the method of any of aspects 1 to 18.

Aspect 21 is an apparatus for wireless communication at a UE, comprising means for performing each step in the method of any of aspects 1 to 18.

Aspect 22 is a computer-readable medium (e.g., a non-transitory computer-readable medium) storing computer executable code, the code when executed by at least one processor causes the at least one processor to perform the method of any of aspects 1 to 18.

Aspect 23 is a method of wireless communication at a satellite, comprising: transmitting, to at least one user equipment (UE) of a set of UEs, a request to initiate a set of measurements associated with a power flux density (PFD) for communication between the satellite and the at least one UE; receiving, from the at least one UE, a report of the set of measurements associated with the PFD based on the request; determining an output power level or a beam pattern based on the report of the set of measurements associated with the PFD; and transmitting, to the at least one UE, at least one transmission based on the output power level or the beam pattern.

Aspect 24 is an apparatus for wireless communication at a satellite, comprising: at least one memory; and at least one processor coupled to the at least one memory, the at least one processor is configured to perform the method of aspect 23.

Aspect 25 is the apparatus of aspect 24, further comprising a transceiver configured to receive or to transmit in association with the method of any of aspect 23.

Aspect 26 is an apparatus for wireless communication at a satellite, comprising means for performing each step in the method of aspect 23.

Aspect 27 is a computer-readable medium (e.g., a non-transitory computer-readable medium) storing computer executable code, the code when executed by at least one processor causes the at least one processor to perform the method of aspect 23.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
obtain a request to initiate a set of measurements associated with a power flux density (PFD) for communication between a set of satellites and the UE;
initiate, based on the request, the set of measurements associated with the PFD; and
transmit, to at least one satellite of the set of satellites, a report of the set of measurements associated with the PFD.

2. The apparatus of claim 1, wherein to obtain the request to initiate the set of measurements associated with the PFD, the at least one processor is configured to:
receive, from one or more satellites of the set of satellites, the request to initiate the set of measurements associated with the PFD.

3. The apparatus of claim 1, wherein to initiate, based on the request, the set of measurements associated with the PFD, the at least one processor is configured to:
determine the set of measurements associated with the PFD; or
perform the set of measurements associated with the PFD.

4. The apparatus of claim 1, wherein the at least one processor is further configured to:
receive, from one or more satellites of the set of satellites, one or more transmissions associated with an output power level or a beam pattern based on the report of the set of measurements associated with the PFD.

5. The apparatus of claim 4, wherein the output power level or the beam pattern is further based on at least one of:
a location of the UE with respect to a center of a beam associated with the one or more transmissions;
a spatial population associated with the UE;
an orientation or an elevation of the at least one satellite of the set of satellites;
a static status of the UE;
a set of beam pattern parameters of the UE;
a weather prediction; or
one or more PFD measurement reports associated with one or more other satellites.

6. The apparatus of claim 1, wherein the at least one processor is further configured to:
initiate a second set of measurements associated with the PFD at an interval based on at least one of a channel state information (CSI) periodicity associated with the UE or a configurable periodicity.

7. The apparatus of claim 1, wherein the request to initiate the set of measurements associated with the PFD indicates a set of UE capabilities for a performance of the set of measurements associated with the PFD.

8. The apparatus of claim 7, wherein the set of UE capabilities comprises at least one of:
a beam width parameter;
a field of view (FoV) of an antenna array of the UE;
a fully digital or hybrid beamforming architecture of the UE;
a size of the antenna array of the UE; or
a static or dynamic status of the antenna array of the UE.

9. The apparatus of claim 1, wherein the request to initiate the set of measurements associated with the PFD indicates a channel on which the UE should perform the set of measurements associated with the PFD.

10. The apparatus of claim 9, wherein the channel corresponds to at least one of a demodulation reference signal (DMRS), a channel state information (CSI) reference signal (RS) (CSI-RS), or a synchronization signal block (SSB).

11. The apparatus of claim 1, wherein the request to initiate the set of measurements associated with the PFD indicates an amount of beams on which the UE should perform the set of measurements associated with the PFD.

12. The apparatus of claim 1, wherein to initiate, based on the request, the set of measurements associated with the PFD, the at least one processor is configured to:
measure a received power of one or more transmissions associated with one or more satellites of the set of satellites; and
extrapolate the received power to determine a corresponding PFD value within a frequency band associated with the one or more transmissions.

13. The apparatus of claim 12, wherein to initiate, based on the request, the set of measurements associated with the PFD, the at least one processor is configured to:
calculate a beamforming gain; and
normalize the beamforming gain to a configurable reference antenna aperture.

14. The apparatus of claim 1, wherein to initiate, based on the request, the set of measurements associated with the PFD, the at least one processor is configured to:
perform the set of measurements associated with the PFD via multiple antenna arrays of the UE.

15. The apparatus of claim 1, wherein to initiate, based on the request, the set of measurements associated with the PFD, the at least one processor is configured to:
determine a power measurement using an analog solution based on a radio frequency (RF) detector or a digital solution, wherein the power measurement is based on a channel used for initiation of the set of measurements associated with the PFD.

16. The apparatus of claim 1, the at least one processor is further configured to:
determine a reliability metric associated with the set of measurements associated with the PFD, wherein the reliability metric is based on at least one of an angle of arrival (AOA) estimation or a beamforming gain associated with the UE.

17. The apparatus of claim 16, the at least one processor is further configured to:
transmit, to one or more satellites of the set of satellites, the report of the set of measurements associated with the PFD, wherein transmission of the report is based on a condition that the reliability metric exceeds a threshold indicated in the request to initiate the set of measurements associated with the PFD.

18. The apparatus of claim 1, wherein the request to initiate the set of measurements associated with the PFD is from one or more satellites of the set of satellites, and wherein the request configures the UE to perform the set of measurements associated with the PFD for transmissions from a different satellite of the set of satellites.

19. A method of wireless communication at a user equipment (UE), comprising:
obtaining a request to initiate a set of measurements associated with a power flux density (PFD) for communication between a set of satellites and the UE;
initiating, based on the request, the set of measurements associated with the PFD; and
transmitting, to at least one satellite of the set of satellites, a report of the set of measurements associated with the PFD.

20. An apparatus for wireless communication at a satellite, comprising:
at least one memory; and
at least one processor coupled to the at least one memory and, based at least in part on information stored in the at least one memory, the at least one processor is configured to:
transmit, to at least one user equipment (UE) of a set of UEs, a request to initiate a set of measurements associated with a power flux density (PFD) for communication between the satellite and the at least one UE;
receive, from the at least one UE, a report of the set of measurements associated with the PFD based on the request;
determine an output power level or a beam pattern based on the report of the set of measurements associated with the PFD; and
transmit, to the at least one UE, at least one transmission based on the output power level or the beam pattern.
